(19) United States
(12) Patent Application Publication
(10) Pub. No.: US 2007/0085968 A1
(43) Pub. Date: Apr. 19, 2007

(54) GUEST-HOST LIQUID CRYSTAL DISPLAY PANEL

(76) Inventors: Wei-Ting Hsu, Tainan County (TW); Chi-Chang Liao, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,395

(22) Filed: Feb. 6, 2006

(30) Foreign Application Priority Data
Oct. 19, 2005 (TW) 94136527

(51) Int. Cl. C09K 19/60

(52) U.S. Cl. 349/165

(57) ABSTRACT

A guest-host liquid crystal display panel comprising a first substrate, a display medium accommodating layer, a display medium, and a second substrate is provided. The first substrate comprises a first patterned electrode layer, and the display medium accommodating layer that has a plurality of micro-cups is disposed on the first patterned electrode layer. The display medium is disposed in the micro-cups of the display medium accommodating layer, and the display medium comprises liquid crystal molecules and dichroic dye molecules. The second substrate having a second patterned electrode layer is disposed over the display medium accommodating layer and the display medium. The guest-host liquid crystal display panel can be applied in a flexible display apparatus. The guest-host liquid crystal display panel can display image without utilizing the polarizer and/or retarder.

### CROSS-REFERENCE TO RELATED APPLICATION

This application claims the priority benefit of Taiwan application serial no. 94136527, filed on Oct. 19, 2005. All disclosure of the Taiwan application is incorporated herein by reference.

### BACKGROUND OF THE INVENTION

1. Field of the Invention

The present invention relates to a guest-host liquid crystal display (LCD) panel, and more particularly, to a guest-host LCD panel with a single liquid crystal layer structure.

2. Description of the Related Art

In order to adapt with modern life, the visual or image display apparatus is becoming lighter and thinner now. Although the conventional cathode ray tube (CRT) display still has its advantages, the CRT display is rather bulky and takes up much space due to its internal electron chamber. Moreover, the CRT display emits radiation harmful to the user's eyes when displaying the image. Accordingly, the flat panel display (FPD) such as the liquid crystal display (LCD), which is developed from optoelectronic technology and semiconductor fabrication technology, has become the main stream of the display products. The common LCDs comprise the twisted nematic liquid crystal display (TN-LCD), the super twisted nematic liquid crystal display (STN-LCD), the thin film transistor liquid crystal display (TFT-LCD), and the guest-host liquid crystal display (GH-LCD). In addition, these different types of LCDs have gradually been applied in different products. The detail of the guest-host LCD panel is described in greater details hereinafter.

FIG. 1 is a schematic cross-sectional view of a conventional guest-host LCD panel. Referring to FIG. 1, the conventional guest-host LCD panel 100 comprises a substrate 110, active matrix substrates 120, 130, and 140, a yellow guest-host liquid crystal layer 150Y, a cyan guest-host liquid crystal layer 150C, and a magenta guest-host liquid crystal layer 150M. The substrate 110 comprises a reflective electrode 112. The active matrix substrate 120 comprises a plurality of thin film transistors (TFT) 122, a plurality of pixel electrodes 124, and an electrode layer 126. The active matrix substrate 130 comprises a plurality of thin film transistors (TFT) 132, a plurality of pixel electrodes 134, and an electrode layer 136. The active matrix substrate 140 comprises a plurality of thin film transistors (TFT) 142 and a plurality of pixel electrodes 144.

In addition, the yellow guest-host liquid crystal layer 150Y is disposed between the substrate 110 and the active matrix substrate 120, and the yellow guest-host liquid crystal layer 150Y is controlled by a voltage difference between the pixel electrode 124 and the reflective electrode 112. The cyan guest-host liquid crystal layer 150C is disposed between the substrate 120 and the active matrix substrate 130, and the cyan guest-host liquid crystal layer 150C is controlled by a voltage difference between the pixel electrode 134 and the electrode layer 126. The magenta guest-host liquid crystal layer 150M is disposed between the substrate 130 and the active matrix substrate 140, and the magenta guest-host liquid crystal layer 150M is controlled by a voltage difference between the pixel electrode 144 and the electrode layer 136.

As shown in FIG. 1, the guest-host LCD panel 100 is a LCD panel with a three-layer structure. Specifically, four substrates are used in the guest-host LCD panel 100 to define three separate rooms for accommodating the yellow guest-host liquid crystal layer 150Y, the cyan guest-host liquid crystal layer 150C, and the magenta guest-host liquid crystal layer 150M. Accordingly, it is difficult to effectively reduce the thickness, weight, and costs of the guest-host LCD panel 100. In addition, the fabrication of the guest-host LCD panel 100 is rather complicated, thus decreasing the product yield.

FIG. 2 is a schematic cross-sectional view of another conventional guest-host LCD panel. Referring to FIG. 2, the guest-host LCD panel 200 comprises a substrate 210, pixel electrodes 220a, 220b and 220c, polymer material layers 230a, 230b, and 230c, guest-host liquid crystals 240C, 240M, and 240Y, a common electrode 250, and a hard coating 260. The pixel electrode 220a is disposed on the substrate 210, the polymer material layer 230a covers the substrate 210 and the pixel electrode 220a, and the guest-host liquid crystals 240C are distributed in the polymer material layer 230a. The pixel electrode 220b is disposed on the polymer material layer 230a, the polymer material layer 230b covers the polymer material layer 230a and the pixel electrode 220b, and the guest-host liquid crystals 240M are distributed in the polymer material layer 230b. The pixel electrode 220c is disposed on the polymer material layer 230b, the polymer material layer 230c covers the polymer material layer 230b and the pixel electrode 220c, and the guest-host liquid crystals 240Y are distributed in the polymer material layer 230c. In addition, the common electrode 250 covers the polymer material layer 230c, and the hard coating 260 covers the common electrode 250.

As shown in FIG. 2, although the guest-host LCD panel 200 is a LCD panel with the three-layer structure, the guest-host LCD panel 200 only uses one substrate. Accordingly, either the thickness, weight or the cost of the guest-host LCD panel 200 can be decreased. However, both of the guest-host LCD panels 100 and 200 are the LCD panels with three-layer structures. Moreover, it is desirable to solve the problem of double image commonly happened in the guest-host LCD panel 100.

### SUMMARY OF THE INVENTION

Accordingly, it is an object of the present invention to provide a color guest-host LCD panel with a single-layer structure without utilizing the polarizer or retarder, thus effectively improving the luminance and decreasing the costs.

In order to achieve the object mentioned above and others, the present invention provides a guest-host LCD panel. The guest-host liquid crystal display panel comprises a first substrate, a display medium accommodating layer, a display medium, and a second substrate. Wherein, the first substrate comprises a first patterned electrode layer, and the display medium accommodating layer is disposed on the first patterned electrode layer and has a plurality of micro-cups located above the first patterned electrode layer. The display medium is disposed in the micro-cups of the display medium accommodating layer, and the display medium comprises liquid crystal molecules and dichroic dye molecules dispersed in the liquid crystal molecules. Moreover, the second substrate having a second patterned electrode layer is disposed over the display medium accommodating layer and the display medium.

In an embodiment of the present invention, the first patterned electrode layer on the first substrate comprises a plurality of pixel electrodes, and the second patterned electrode layer on the second substrate is a common electrode. In another embodiment of the present invention, the first patterned electrode layer comprises a plurality of first strip electrodes, and the second patterned electrode layer comprises a plurality of second strip electrodes.

In an embodiment of the present invention, the display medium accommodating layer is made of a transparent dielectric material or a dielectric material with the reflective effect.

In an embodiment of the present invention, the guest-host LCD panel may further comprise a plurality of color filter layers, and the color filter layers are disposed in the micro-cups of the display medium accommodating layer, respectively. For example, the color filter layers may be disposed above the display medium. Alternatively, the color filter layers may be disposed below the display medium.

In an embodiment of the present invention, the color filter layers comprises a plurality of first color filter layers, a plurality of second color filter layers, and a plurality of third color filter layers. The first, second, and third color filter layers are suitable for cooperating with the display medium to block the light (i.e. in a dark state).

In an embodiment of the present invention, the display medium may be capsulated.

### BRIEF DESCRIPTION DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 is a schematic cross-sectional view of a conventional guest-host LCD panel.

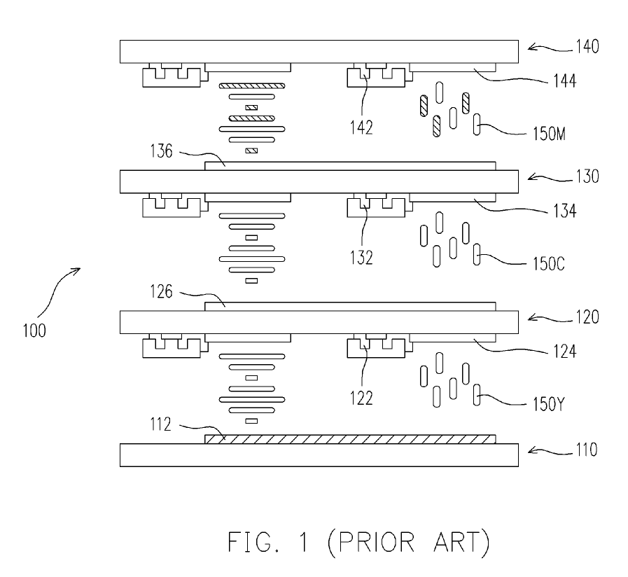

FIG. 2 is a schematic cross-sectional view of another conventional guest-host LCD panel.

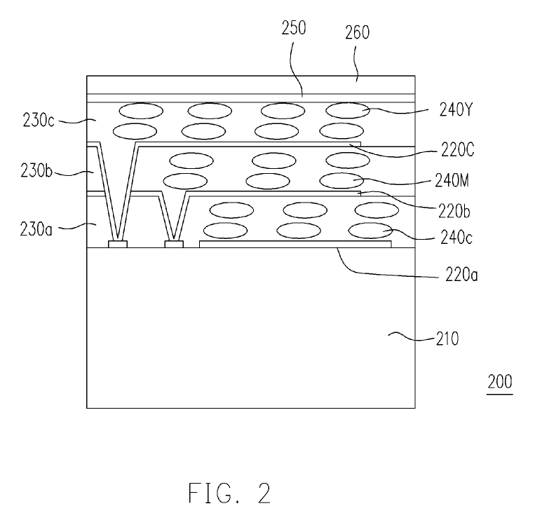

FIG. 3 is a schematic cross-sectional view of a guest-host LCD panel according to a first embodiment of the present invention.

FIG. 4 is a schematic cross-sectional view of a guest-host LCD panel according to a second embodiment of the present invention.

FIG. 5 is a schematic cross-sectional view of a guest-host LCD panel according to a third embodiment of the present invention.

FIG. 6 is a schematic cross-sectional view of a guest-host LCD panel according to a fourth embodiment of the present invention.

### DESCRIPTION PREFERRED EMBODIMENTS

### First Embodiment

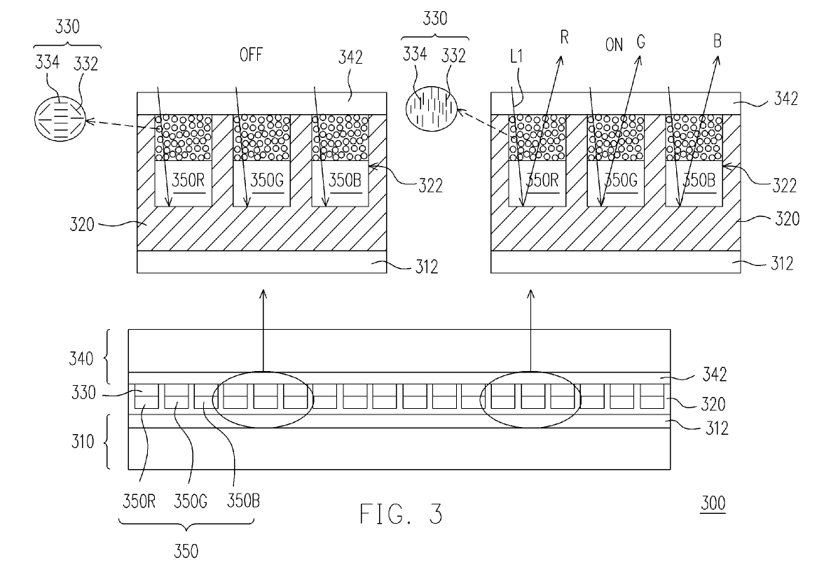

FIG. 3 is a schematic cross-sectional view of a guest-host LCD panel according to a first embodiment of the present invention. Referring to FIG. 3, the guest-host liquid crystal display panel 300 of the present embodiment comprises a first substrate 310, a display medium accommodating layer 320, a display medium 330, a second substrate 340, and a plurality of color filter layers 350. The first substrate 310 has a first patterned electrode layer 312, and the display medium accommodating layer 320 is disposed on the first patterned electrode layer 312. The display medium accommodating layer 320 has a plurality of micro-cups 322 located above the first patterned electrode layer 312. The display medium 330 is disposed in the micro-cups 322 of the display medium accommodating layer 320, wherein the display medium 330 comprises liquid crystal molecules 332 and dichroic dye molecules 334 dispersed in the liquid crystal molecules 332. Moreover, the second substrate 340 having a second patterned electrode layer 342 is disposed on the display medium accommodating layer 320 and the display medium 330.

In the present embodiment, the display medium accommodating layer 320 is made of a dielectric material with the reflective effect. Of course, the display medium accommodating layer 320 may be made of a transparent dielectric material. If the display medium accommodating layer 320 is made of a reflective material, the guest-host LCD panel 300 is regarded as a reflective LCD panel. If the display medium accommodating layer 320 is made of a transparent material, the guest-host LCD panel 300 is regarded as a transmissive LCD panel. Certainly, the display medium accommodating layer 320 may be fabricated with a combination of the reflective material and the transparent material, such that the guest-host LCD panel 300 becomes a transflective LCD panel.

In addition, the display medium 330 of the present embodiment may be capsulated. Of course, the capsulated display medium 330 is only for description, the present invention is not limited to the certain type of the display medium, and other display medium 330 having the liquid crystal molecules 332 and the dichroic dye molecules 334 is also suitable for the present invention.

It is noted that both of the color filter layers 350 and the display medium 330 are disposed in the micro-cups of the display medium accommodating layer 320, and the display medium 330 is disposed above the color filter layers 350. In the present embodiment, the color filter layers 350 comprise a plurality of red color filter layers 350R, a plurality of green color filter layers 350G, and a plurality of blue color filter layers 350B. The red color filter layers 350R, the green color filter layers 350G, and the blue color filter layers 350B are suitable for cooperating with the display medium 330 to block the light L1 (in the “OFF” state). In other embodiment, the color filter layers 350 may be composed of color filter layers in other colors.

It is known from the upper left part in FIG. 3, when a pixel in the guest-host LCD panel 300 is in the “OFF” state, the light L1 emitted to the pixel is absorbed by the dichroic dye 334 inside the display medium 330, the red color filter layers 350R, the green color filter layers 350G, and the blue color filter layers 350B, such that the pixel displays a black color. Moreover, it is known from the upper right part in FIG. 3, when a pixel in the guest-host LCD panel 300 is in the “ON” state, the light L1 emitted to the pixel is not absorbed by the dichroic dye 334 inside the display medium 330, and the light L1 becomes a red light R, a green light G, or a blue light B after passing through the red color filter layers 350R, the green color filter layers 350G and the blue color filter layers 350B, respectively.

### Second Embodiment

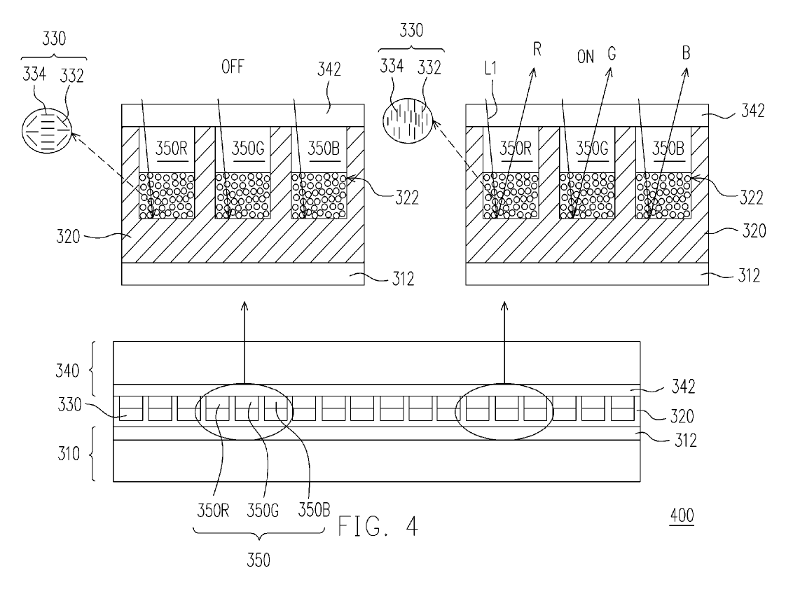

FIG. 4 is a schematic cross-sectional view of a guest-host LCD panel according to a second embodiment of the present invention. Referring to FIG. 4, the guest-host LCD panel 400 of the present embodiment is similar to the guest-host LCD panel 400 of the first embodiment, and the only difference is the location of the color filter layers 350 relative to the display medium 330. In the present embodiment, the color filter layers 350 are disposed above the display medium 330.

### Third Embodiment

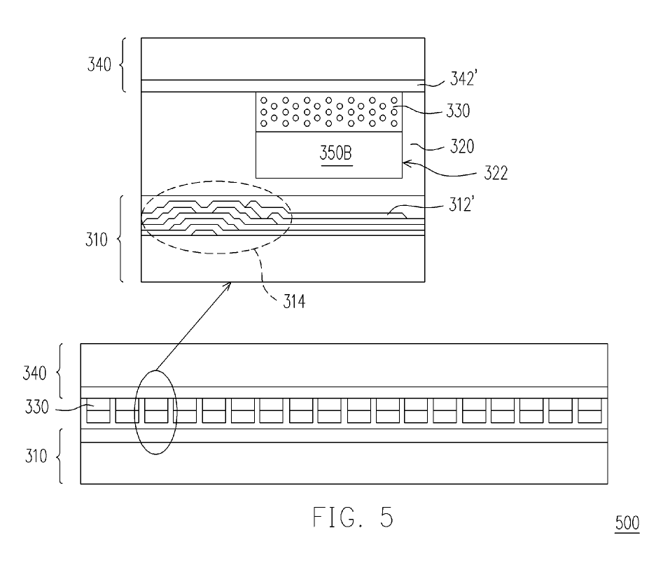

FIG. 5 is a schematic cross-sectional view of a guest-host LCD panel according to a third embodiment of the present invention. Referring to FIG. 5, in the guest-host LCD panel 500 of the present embodiment, the first substrate 310 is an active matrix substrate having an active device 314 (e.g. a TFT) and a pixel electrode 312′. The opposite second substrate 340 has a common electrode 342′. The descriptions of other components are omitted herein.

### Fourth Embodiment

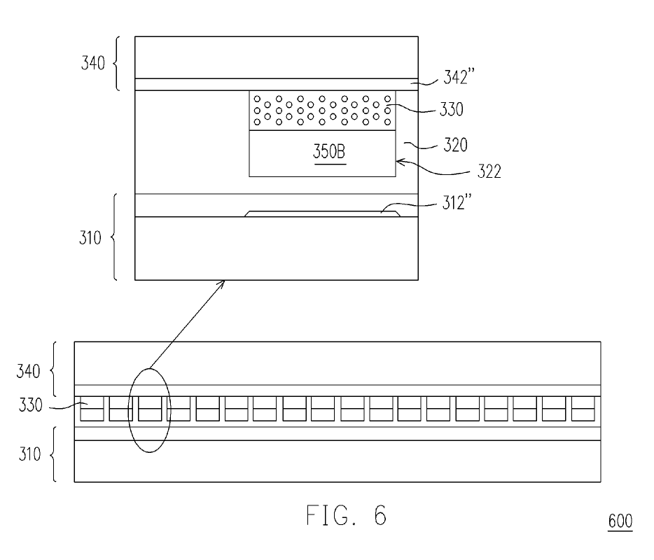

FIG. 6 is a schematic cross-sectional view of a guest-host LCD panel according to a fourth embodiment of the present invention. Referring to FIG. 6, in the guest-host LCD panel 600 of the present embodiment, the first substrate 310 is a passive matrix substrate having strip electrodes 312″, and the opposite second substrate 340 has strip electrodes 342″. The descriptions of other components are omitted herein.

In summary, the guest-host LCD panel of the present invention at least has following advantages:

1. Since the guest-host LCD panel of the present invention has a single-layered liquid crystal structure, it is thinner and lighter than the conventional guest-host LCD panels. In addition, the guest-host LCD panel of the present invention does not have the double image problem.

2. Since the image display of the guest-host LCD display is not easily impacted by its thickness variance, the guest-host LCD panel of the present invention can be applied in a flexible display apparatus and can be fabricated with a continuous type fabrication process.

3. The fabrication process of the guest-host LCD panel of the present invention is relatively simple, which significantly improves the product yield.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed descriptions.

What is claimed is:

1. A guest-host liquid crystal display (LCD) panel, comprising:
a first substrate having a first patterned electrode layer;
a display medium accommodating layer disposed on the first patterned electrode layer of the first substrate, wherein the display medium accommodating layer comprises a plurality of micro-cups disposed above the first patterned electrode layer;
a display medium disposed in the micro-cups of the display medium accommodating layer, wherein the display medium comprises:
a plurality of liquid crystal molecules; and
a plurality of dichroic dye molecules dispersed in the liquid crystal molecules; and
a second substrate disposed over the display medium accommodating layer and above the display medium, wherein the second substrate comprises a second patterned electrode layer.

2. The guest-host LCD panel of claim 1, wherein the first patterned electrode layer on the first substrate comprises a plurality of pixel electrodes, and the second patterned electrode layer on the second substrate is a common electrode.

3. The guest-host LCD panel of claim 1, wherein the first patterned electrode layer comprises a plurality of first strip electrodes, and the second patterned electrode layer comprises a plurality of second strip electrodes.

4. The guest-host LCD panel of claim 1, wherein a material of the display medium accommodating layer comprises a dielectric material.

5. The guest-host LCD panel of claim 1, wherein a material of the display medium accommodating layer comprises a reflective material.

6. The guest-host LCD panel of claim 1, further comprising a plurality of color filter layers disposed in the micro-cups of the display medium accommodating layers, respectively.

7. The guest-host LCD panel of claim 6, wherein the color filter layers are disposed on the display medium.

8. The guest-host LCD panel of claim 6, wherein the display medium is disposed on the color filter layers.

9. The guest-host LCD panel of claim 6, wherein the color filter layers comprise:
a plurality of first color filter layers;
a plurality of second color filter layers; and
a plurality of third color filter layers, wherein the first color filter layers, the second color filter layers, and the third color filter layers are suitable for cooperating with the display medium to block a light.

10. The guest-host LCD panel of claim 1, wherein the display medium is in a capsulated form.
